(19) United States
(12) Patent Application Publication
(10) Pub. No.: US 2004/0148054 A1
(43) Pub. Date: Jul. 29, 2004

(54) Method and system for packaging and dispensing medication

(76) Inventor: Monty Schwartz, Longmeadow, MA (US)

Correspondence Address: Stephen P. Scuderi, Esq., McCormick, Paulding & Huber LLP, 185 Asylum Street, City Place II, Hartford, CT, 06103, US

(21) Appl. No.: 10/350,976

(22) Filed: Jan. 24, 2003

(51) Int. Cl. G06F 17/60; G06F 17/00

(52) U.S. Cl. 700/231; 705/2

(57) ABSTRACT

A method and system for dispensing prescription medication to a patient over a select time period including at least one prescription package. The package has a plurality of discrete spatially distinct locations containing the medication arranged in a two dimensional matrix. The matrix includes data corresponding to time of day information and select number of days of a week information. A heading region is disposed on a portion of the package. The heading region contains prescription instruction data having the patient's name, medication name, medication dosages and usage schedule. A scheduling code is disposed on an end of the prescription package. The scheduling code corresponds to the same time of day information as in the matrix. The medication is disposed in the discrete spatially distinct locations to correspond to the medication dosages and usage schedule of the prescription instruction data.

### COPYRIGHT AND MASK WORK NOTICE

A portion of the disclosure of this patent document contains material, which is subject to copyright and mask work protection. The copyright and mask work owner reserves all copyright and mask work rights whatsoever.

### FIELD OF THE INVENTION

The present invention relates to a method and system for packaging and dispensing medication, and more particularly to a method and system of packaging and dispensing daily medication for a select period.

### BACKGROUND OF THE INVENTION

Large wholesale pharmaceutical supply houses (wholesale pharmacies), which service long term patient care facilities, e.g., nursing homes, assisted living, hospices, prisons, schools and the like, normally fill a minimum of a month's supply of medications per patient. This is because the fixed costs of processing, handling and shipping smaller supplies for lesser time periods become disproportionately too high to achieve profitability at wholesale prices.

Moreover, the prior art medication dispensing systems, utilized by the wholesale pharmacies, have difficulty tracking the numerous potential changes and adjustments often encountered in a long term care patient's prescription. Accordingly, the month's supply of medications are sent to a patient care facility (or care group) and billed at the time the drugs are dispensed.

However, many patients do not necessarily require 30 day doses of a single medication. Also, doctors frequently need to change prescriptions because of drug intolerance or ineffective dosage for a particular patient. Furthermore, a large percentage of patients having a mental health diagnosis, that are prescribed medications, require adjustment of the dosage or a change in medication altogether. Psychiatrists frequently change drug therapy and dosage strength of the same drug. Whenever the drug or dosage changes, than by either law or for general safety reasons, the remainder of the thirty-day supply must be discarded. Discarding the medications is not only wasteful but can be extremely expensive.

For instance, if a patient has a prescription order for 5 mg tablets of a drug with directions for dispersing one at bedtime, a traditional long term care pharmacy serving a nursing home will fill 30 days of medication and bill at the time filled. If the doctor increases the strength from 5 mg to 7.5 mg after a week, the pharmacy will fill a new order for 30 tablets, and a second billing will be issued. Typically, if medication for a particular patient is changed two or three times in the course of a month, two or three months of supplies will be generated, two or three deliveries to the institution will be arranged by the pharmaceutical house, and two or three separate invoices will be generated for each medication.

Also, long-term care groups typically rely on the pharmacist, doctor or psychiatrist to monitor for drug interactions, allergies and the like. This method of monitoring is notoriously inadequate. Many patients in long term care have more than one doctor making it less likely that each doctor is even aware of all of the medications being taken by the patient. If the doctor is unaware of all of the medications prescribed to the patient, then there is no way to monitor for drug interactions or allergies. Likewise, pharmacists are at a similar disadvantage in monitoring for drug interactions, and may not be aware of drug allergies and the like. If more than one pharmacy or pharmacist is being used, it becomes more difficult to monitor drug interactions simply because the pharmacies and pharmacists are unaware of all of the drugs being consumed by a particular patient. Furthermore, many pharmacists are too busy to monitor all the medications being administered to a single patient.

Wholesale pharmacies will periodically deliver prescription packages of medication to a large number of patients residing in a variety of patient care facilities within a geographic region. Moreover, even a single complex of buildings may be designated by management to have more than one patient care facility, depending on the needs of the patients residing therein. The delivery dates of the prescription packages will often differ among the facilities depending on location and/or administrative needs.

The starting dates that the packaged medications must be administered to the patients will depend in large part upon when the packages are delivered to each facility. Problematically however, the packages are standardized to contain the same start date for each package, regardless of when they are delivered to a facility. This means that a significant portion of the medication in a package will often be discarded and wasted, because it was scheduled to be consumed before it was actually delivered to the patients in a particular facility.

Although, software programs may be available to help monitor drug distribution in a hospital environment, such programs are typically not available to or used by long care health facilities; and even where such software programs are available, the medications are still typically distributed manually resulting in continued danger of the wrong medication being administered to the patient. Moreover, the software programs are typically associated with prior art medication dispersal systems that require a 30-day minimum supply.

Medication dispensers designed to deliver a week's worth of medication corresponding to the time of day are also known. For example, U.S. Pat. No. 4,640,560 issued to Blum teaches a pill dispenser for dispensing daily medications for a week, in which the pill dispenser has a housing and a plurality of compartments having little doors for dispensing medication in pill form therefrom. The compartments (or pillboxes) in the invention of Blum are arranged in columns and rows wherein the columns represent the day of the week and the rows represent the hourly parts of the day. The invention of Blum requires the compartments to be filled manually permitting errors in dose and drug interactions to occur.

Additionally, each pillbox of Blum stores all the medications to be taken at a particular hour and day corresponding to the particular compartment in which it is inserted. This arrangement must inherently mix medications in each pillbox, which makes it difficult to change, or keep track of, adjustments in a patient's prescription.

Systems for preparing and dispensing packaged medication to a large number of patients in a health care facility are also known. For example, U.S. Pat. No. 3,826,222, herein incorporated by reference, issued to Romick discloses a system for handling and dispensing pre-packaged unit doses of medication for a large number of patients which include a dispensing container packed by a pharmacist with unit dose packs having indicia disposed thereon with instructions for time of delivery and other conditions for administering the unit doses. The prepackaged unit doses of the Romick invention are not arranged according to day/time of day. Furthermore, the prepackaged unit doses are filled manually permitting errors in dose and drug interaction to occur. Moreover, if multiple medications are prescribed for a patient, any change in any one medication would require that the entire prepackaged unit for that patient be discarded.

U.S. Pat. No. 5,169,001, herein incorporated by reference, issued to Scheibel describes a container which holds blister cards in a vertical position and in sequential arrangement by the prescribed time of day. The blister cards contain a single medication per time of day per month. In other words, the blister cards contain medication for dispersal in the morning, at noon, in the evening, at bedtime and as needed for an entire month's time. Indicia including warnings, patient name, and time of desired administration of the medication are disposed on each blister card.

Each blister card of the invention of Scheibel is “adapted to include thirty one blister cavities, which is sufficient to hold one month's supply of a particular medicament to be taken at a particular time of day” (see Scheibel, col. 4, lines 15-18). Accordingly, since the blister packs are arranged on a monthly basis, any change in a patient's medication would require the entire month of medication to be discarded.

U.S. Pat. No. 5,368,187, herein incorporated by reference, issued to Poncetta et al. teaches a dispenser and method for dispensing materials from a blister pack of one or more blister cards. A single blister card having a plurality of blisters thereon can be used with other blister cards in a stack. To dispense materials from the aligned blisters of arranged blister cards, a plunger is driven through a guide hole in a top plate and into aligned blisters of a stack of blister cards. In this way, a plurality of blisters can be quickly and cleanly opened.

However, in Poncetta et al., no indicia can be seen differentiating the blister packs from one another. Additionally, there is no teaching or suggestion of any system of packaging and dispensing daily medication for a select period of time.

None of the above inventions and patents, taken either singularly or in combination, are seen to describe the instant invention as claimed.

### SUMMARY OF THE INVENTION

The present invention relates to a method and system of dispensing prescription medications to a patient over a select time period. The method includes receiving a prepared prescription for medication containing prescription data and patient parameters for a select patient. The prescription data and patient parameters are stored, such as in a computer. A prescription package is provided having a plurality of discrete spatially distinct locations arranged in a two dimensional matrix. The two dimensional matrix includes data corresponding to time of day information and a select number of days of a week information. Additionally the prescription package has a heading region disposed on a portion of the package. The prescription data is compared to the patient parameters to determine prescription instruction data. The prescription instruction data is printed onto the heading region. The prescription instruction data includes at least the patient name, medication name, medication dosage and dosage schedule. The medication is packaged in the discrete spatially distinct locations to correspond to the medication dosages and dosage schedule of the prescription instruction data. A scheduling code is placed on an end of the prescription package. The scheduling code corresponds to the same time of day information as in the matrix.

### BRIEF DESCRIPTION OF THE DRAWINGS

The novel features of the described embodiments are specifically set forth in the appended claims; however, embodiments relating to the structure and process of making the present invention, may best be understood with reference to the following description and accompanying drawings.

FIG. 1 is a perspective view of blister package cards according to the present invention arranged vertically in a cart.

FIG. 2 is a plan view of a blister package card according to the present invention.

FIG. 3 is a plan view of a second embodiment of a blister package card according to the present invention.

FIG. 4 is a plan view of a color-code chart utilized with the present invention.

FIG. 5 is a flow chart of a method for packaging a blister package card according to the present invention.

FIG. 6 is a flow chart depicting additional steps of a method for packaging a blister package card of FIG. 5 according to the present invention.

Similar reference characters denote corresponding features consistently throughout the attached drawings.

### DETAILED DESCRIPTION OF PREFERRED EMBODIMENTS

In a preferred exemplary embodiment, a one-week supply of each medication is provided by the present invention and billed at the end of the month instead of when the drug is dispensed. If the medication is prescribed and not discontinued or changed, a one week supply is filled at a time, and then billed at the end of four weeks (a 28-day supply) resulting in a bill for 28 doses. On the other hand, if the doctor changes the prescription after a week, the patient is only billed for what is sent out plus the dispensing fee. The present invention would save the difference between one week and the conventional 30-day supply.

Once the pharmacy receives the prescription, the authorization blank from the doctor and the set of prescriptions written for a one-week supply, the pharmacy utilizing the present invention will initiate service to the client. The prescription will contain prescription data, e.g., medication names, medication dosages and dosage schedules, as well as patient parameters, e.g., patient names and allergies to medications.

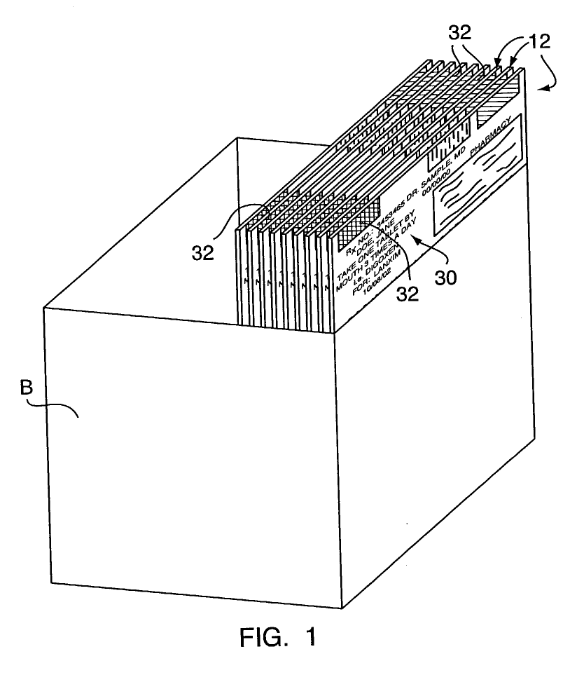

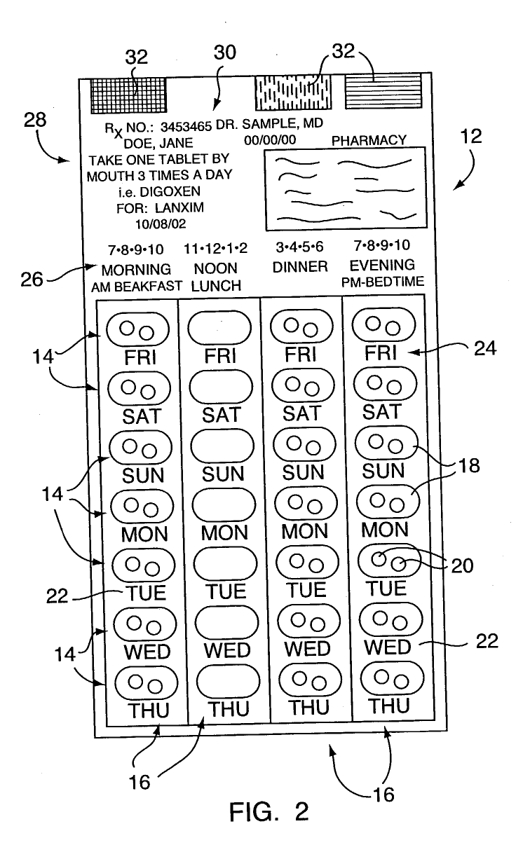

Blister packages are utilized in the practice of the present invention, as shown in FIGS. 1, 2 and 3. Each blister package (blister pack) 12 preferably has seven rows 14, shown in FIG. 2, corresponding to the day of the week and four, five or six columns 16 of blister cavities 18 corresponding to the time of day the medication 20 is to be taken. Though this embodiment illustrates blister packs with blister cavities, one skilled in the art would recognize that other packages with discrete spatially distinct locations for medications or other substances are within the scope of this invention, e.g., birth control packages having compartments for birth control pills.

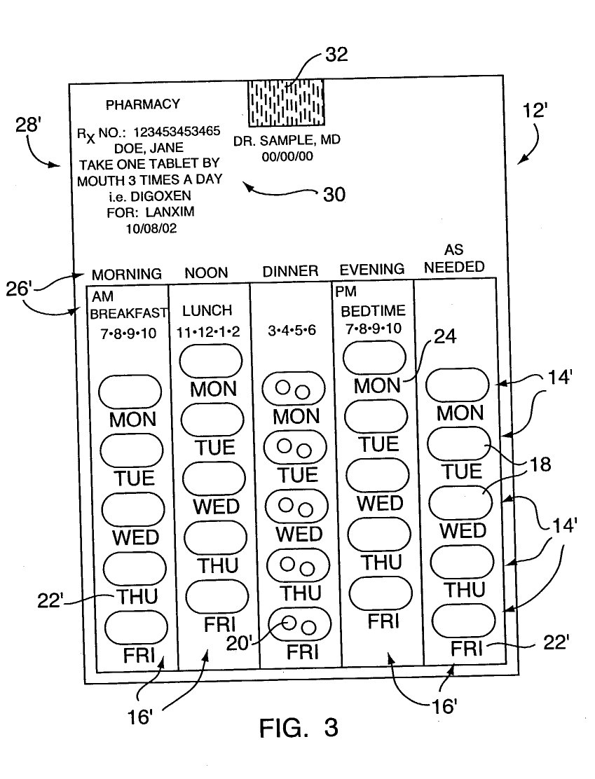

The blister packages may be provided with five rows 14′, as shown in FIG. 3, for medications 20′ which are prescribed for only five day regimens. Data in the form of indicia are provided on each blister package indicating the day of the week, as denoted by the numeral 22 in FIGS. 2 and 22′ in FIG. 3, under each blister cavity 18. The first day 24 indicated on the blister pack is the first day of the week that the medication should initially be consumed. For example, the first day 24 may be a Monday as shown in FIG. 3 or a Friday as shown in FIG. 2, but may just as well be any other day of the week as desired.

This first day 24 is also the delivery date to a particular facility, as well as the start date that the medication should be administered to the patients within the facility. For the convenience of the patient care facilities, this start date is customized to, and made uniform for, each facility. This provides for easier tracking of the medications as they are consumed by the patients. Moreover, the customized start date significantly reduces waste by helping to assure that no portion of the packaged medication will be discarded by reason of the delivery date and the scheduled start date not matching.

The time of day that the medication is to be taken, as indicated by indicia 26 at the top of each column in the heading region 28 consists of “morning”, “noon”, “dinner”, and “evening” when four columns are used, as shown in FIG. 2. Alternatively, an additional one or two columns may be provided having indicia disposed at the top of each column indicating the time of day as “as needed” and/or “night”. The time of day indicia 26 may further indicate that medication under the “morning” column is to be consumed from 7 AM to 10 AM and/or at breakfast, “noon” from 11 AM to 2 PM and/or at lunch, “dinner” from 3 PM to 6 PM, “evening” from 7 PM to 10 PM and/or bedtime, and “night” from 11 PM to 6 AM. The present invention is not limited, however, to the specific time of day indicia shown and alternative analogous indicia such as symbols may be used.

Advantageously, each blister pack 12 and 12′ has disposed thereon patient parameter information, such as prescription information indicia 30, as shown in FIGS. 1, 2 and 3, in the heading region 28 of the blister pack. The prescription information indicia 30 includes doctor's name, prescription number or code, date prescribed, instructions and precautions, patient's name, name and strength of the medication contained in the blister package, number of refills available, and the expiration date. Medication is disposed in the blister cavities 18 of the columns 16 corresponding to the time of day the medication is to be administered as indicated in the prescription information indicia 30.

Only blister cavities 18 corresponding to the prescribed times for taking the medication, as indicated by the instructions found in the prescription, are filled with medication 20. A corresponding scheduling code, such as a color coded sticker or tab 32, is placed above each time of day indicia 26, as shown FIGS. 1, 2 and 3, to clearly indicate from the top of the card when the medication is to be administered. The color code 32 is added to the top of the column containing the medication, as shown. As many color codes 32 are disposed on the top of the column in the header region 28 as required for the frequency of administration of the medication per the prescription. Though this embodiment shows the scheduling code at the top of each column to be a color-coded sticker, other scheduling code devices may also be used, e.g., tabs.

Accordingly, a single blister pack 12 forms a two dimensional scheduling matrix of select day information, e.g., days of the week 22, and select times of day information, e.g., morning, noon, dinner and evening 26. When this scheduling matrix becomes advantageously combined with the patient parameter information 30 in the heading region 28 of the blister pack 12, all of the information necessary to administer a particular medication is clearly displayed at a glance. Moreover, when the added scheduling code at the top of the blister pack 12 is combined with the two dimensional matrix on each blister pack, a three dimensional medical matrix display apparatus is formed, in which multiple blister packs for dispensing multiple medications can be utilized.

In this three dimensional matrix embodiment there is uniformity of packaging for individual medications such that the nurse practitioner can readily identify the patient, the medication and most importantly any variations or discrepancies between prescription and that which is being delivered to the patient. This preferred embodiment comes as a series of blister packs 12 which are stacked or arranged in a vertical order with the mediations progressing from earliest morning to evening in a left to right hand fashion. In addition, the series of color codes associated with each medication clearly indicate the times at which the medication is to be consumed. Consequently, it becomes more difficult to mistakenly give a patient medication at the wrong time of day, e.g., an evening medication in the morning, because it would be visually at variance with the sequence of scheduling color codes.

The present invention contemplates a computerized algorithm for generating the appropriate prescription instruction data for the cards. The prescription instruction data is determined by comparing the prescription data to the patient parameter data of the prescription.

These cards are quickly and easily generated by the pharmaceutical company or distributor so that each medication is presented in substantially the same fashion. Consequently, if the doctor changes one of the prescriptions for the patient from 5 milligrams to 7.5 milligrams of dosage, the nurse practitioner can then simply remove the appropriate card from the stack and replace it with a new one. Since the preferred embodiment provides less than the normal 30 day supply, e.g., 5 or 7 days, there is not only a savings in overall cost, but it simplifies the efforts of the nurse practitioner in maintaining an orderly dispensation of the medications.

In another aspect of the present invention, the computerized algorithm also includes further patient parameters in the form of a profile for the individual patient. This profile stores the base dosage history for all the medications given to that patient over the period of time contemplated. Consequently, the algorithm can provide direct confirmation of all the medications that the patient has received, and can also be programmed to generate an alarm should either an incorrect dosage level be keyed in, or, if there is a certain combination or sub-combination of drugs whose side effects are to be avoided. For example, if a doctor modified the dosage from 5 to 7 milligrams, but the modification was incorrectly keyed in as a 70-milligram dosage, the system may be programmed to generate an alarm. Similarly, certain drugs which can be used alone without harmful side effects, are harmful when combined with certain other drugs. These harmful combinations can be monitored by the algorithm, and an alarm can be programmed to generate should any undesired combination of prescriptions be detected.

The blister packs 12 are placed in a container B, as shown, so the color coded stickers or tabs 32 can be seen from the top. This permits the nurse or other health care provider to determine at a glance when the medication should be given to the patient. It is preferable to arrange the blister packs 12 in the container B such that the medications to be administered in the morning are first, the medications to be administered at lunch are next, and so forth. This is not entirely possible as many medications are to be administered twice a day, three times a day, only with meals and so forth, but it is desirable to arrange the blister packs as close as possible to the desired order. In practice, this means grouping the color-coded stickers or tabs together starting with the left-hand side. The colors on the different stickers may be any color as desired. For example, yellow may represent 7 AM to 10 AM, orange may represent 11 AM to 2 PM, purple may represent 3 PM to 6 PM, blue may represent 7 PM to 10 PM, and black may represent 11 PM to 6 AM. When it is time for the medications to be administered, the health care provider arranges the blister package cards 12 according to the time of day to administer them to the patients.

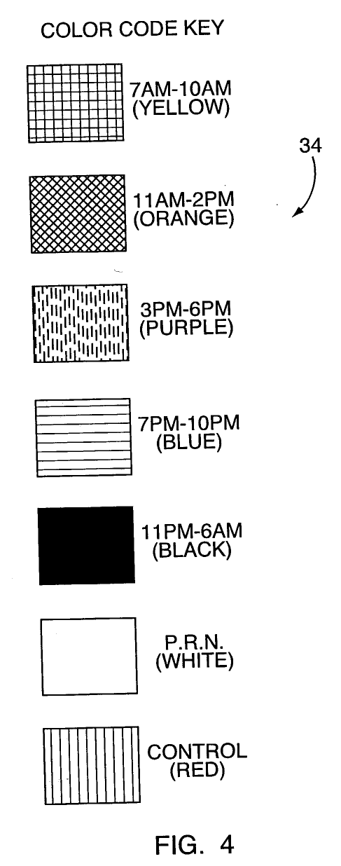

Additional colors may be used to further indicate that the pharmaceuticals are controlled substances or to be administered as needed. For example, red may represent controlled substances and white may represent as needed administration. Stripped color-coded stickers or tabs may be provided such that a controlled drug may still be color-coded by the time of day. Furthermore, occasionally medications may be prescribed to be taken at certain given times, or increments of time, or as needed. In which case, stripped color-coded stickers or tabs may be provided to indicate that the medication should be administered at certain times of day or as needed. A color code key 34 is provided to identify the time of day accordingly, as shown in FIG. 4.

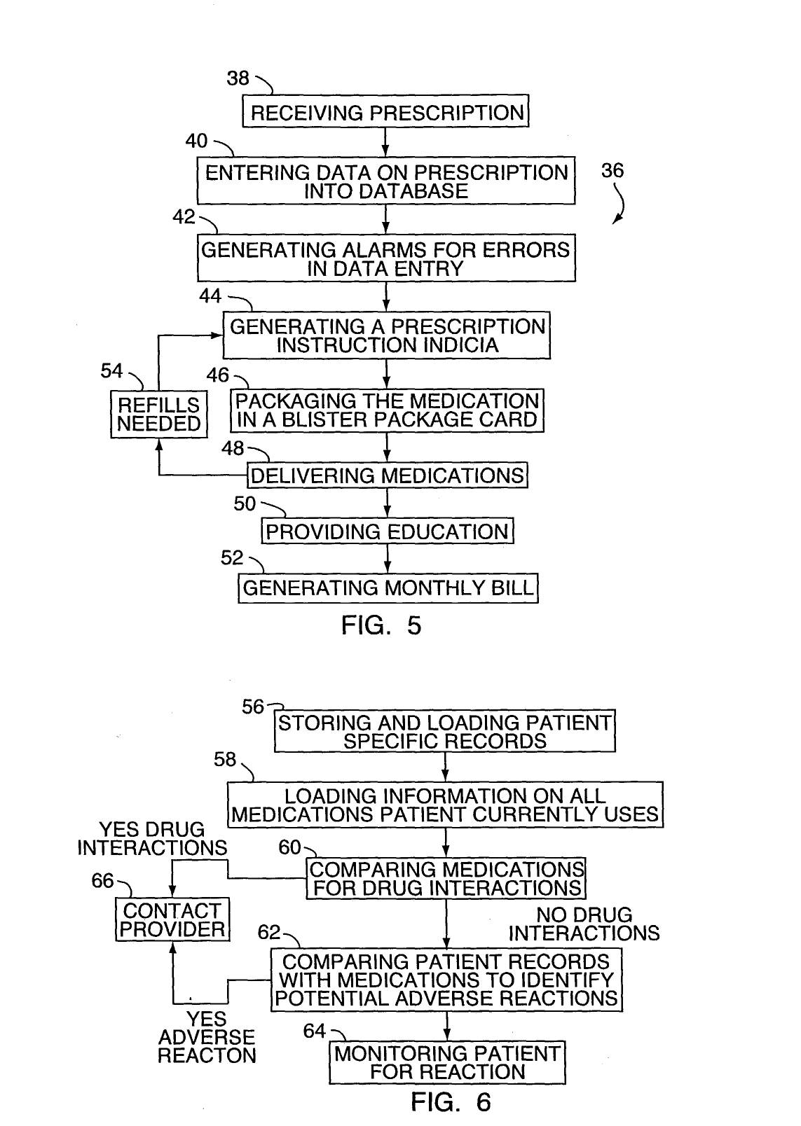

The method of the present invention 36, shown in FIGS. 5 and 6, begins with the pharmacy receiving 38 the prescription, entering the data into a computerized database 40, followed by packaging the medications 46. The medications are packaged by units of use, i.e., dose, with one dose in each blister cavity, and only a single medication is packaged in each blister pack. If, for example, a patient is scheduled five oral medications, five blister packs will be filled each week. An exception occurs with “as needed” (PRN) medications, which are filled only when ordered. The medications are distributed as indicated on an assessment form, and maybe distributed via pick up, direct delivery to patient, indirect delivery to an agency or clinic, and mail. Drug information sheets are provided for the first fill for each new medication for the client. The most common side effects for each medication will be included on the prescription information indicia of each blister pack.

Exceptions and modifications to the standard fill process are possible. Different blister packs may be provided weekly, for the same patient and medication, for AM and PM doses. Leave of absence may be packaged on separate blister pack cards. Color-coded cards for patients who cannot read may be provided. Icons such as the sun in the morning and the moon in the evening may be added. Scheduled medications may be filled on the blister pack cards while as needed medications may be filled on conventional numbered cards. Furthermore, two weeks worth of medications may be packaged at a time for patients who are being taught to self-medicate. Split deliveries are also possible; for example, medications may be delivered to a day care program for the day and to the residence for nighttime, or to a respite location during the day and an agency office for nighttime. If desired, it is also possible to package and deliver as little as one day at a time, such as when a patient might overdose. Optionally, it may be desirable to package two strengths of the same medication on one blister pack card. Also, it is possible to pre-fill a medication box in which all doses for a particular time of day are packaged in one blister cavity. The present invention additionally contemplates the possibility of providing more than one type of medication in single blister cavities on the same blister pack cards as appropriate for the patient.

Though the present exemplary embodiment discusses the use of blister packs to dispense medication, one skilled in the art would recognize that the blister packs may be used to dispense other substances in a time sensitive manner as well. For example, the blister packs may be used to dispense vitamins and other nutritional supplements, or animal as well as human medications.

When refills are used up, the prescriber(s) of the medication are contacted to determine if the medications should be continued 66. Drug profiles are reviewed for interactions on a weekly basis. The patients, or other clients, are educated on the use of the system and the prescribed medication(s). The prescriber or their staff will notify the pharmacy when a medication has been discontinued or when the dose has changed. If a physician writes a monthly order for a patient, then the prescription will be returned by the pharmacy for a rewrite with a note attached, such as “THIS CLIENT IS ON A MONITORED RX PROGRAM. RXS ON FILE NEED TO BE WRITTEN FOR A 7-DAY SUPPLY FOR PAYOR AUDIT. REFILLS ZERO TO 12 WEEKS.”

Delivery drivers will normally deliver approximately 48 of the prescribed medications weekly for a given patient or client. It is necessary for the client or other designated persons to be available to receive the delivery unless alternate arrangements are made in advance. If undeliverable, the driver will attempt another delivery the next day or, alternatively, call the client to make arrangements. Refills will automatically be delivered until completed 54.

For use in long-term care facilities, such as assisted living, nursing homes and prisons, the previous process is modified. Prescriptions are written for a 28-day month. Scheduled oral prescription orders are filled weekly on the blister pack cards and automatically delivered to the facility weekly for four weeks. This saves time for the health care providers, such as nurses, because only PRN, new and discontinued medications have to be called in to the pharmacy. Furthermore, the color-coded stickers are added for each dose of each medication according to the color chart 34, as shown in FIG. 4, which is provided the long-term care facility. The color-coding system permits the administrator or other supervisory health care provider to verify the accuracy and status of each medication pass. Color-coding saves the medication pass nurse time because the nurse presets the blister pack card in a medication wagon by color by medication pass time. Packaging all of the medication of the same kind on one blister pack card will confirm that the previous dose has been passed.

It is preferred to bill the payor at the end of each 28-day cycle 52 for the cost of that amount of each drug dispensed on the blister pack cards plus one filling fee for each medication. If a medication has been filled for only one week and discontinued, or has had the strength of the dose changed, the pharmacy utilizing the present invention will only charge for that one weeks quantity plus one dispensing fee. The net result will be a huge cost saving to the payor whether a private payor, Medicaid, other third party payor or a facility payor. Payment is based on quantity actually dispensed and received. Furthermore, the health care professionals at the long-term care facility will not be burdened with the tedious task of pressing many doses out of a 30-day nursing home card and flushing them.

After receiving the prescription 38, the pharmacy enters the data into a database 40. Alarms may be generated when data is entered incorrectly 42. The prescription instruction indicia 44 are generated by the computer and printed out therefrom. Next, the medication is packaged in the blister package card 46, and delivered to the patient or caregiver 48. The medication is then refilled until no more refills are available 54.

The present invention also provides education to the patient or care provider 50. An information sheet is provided to the patient or care provider as well. Also, as mentioned hereinabove, the present invention contemplates the storage and loading of patient specific records 56. All of the medications for a patient's current uses are included in the database and loaded into the computer 58. All of the medications taken by the patient are compared to identify drug interactions 60. Also, the patient records are compared with the medication in order to identify potential adverse reactions to the medications 62 prescribed. If either drug interactions or potential adverse reactions are discovered, the prescriber is contacted for further directions 66 before the prescription is filled. Furthermore, the present invention contemplates monitoring the patient for adverse reactions 64.

It is to be understood that the present invention is not limited to the embodiments described above, but encompasses any and all embodiments within the scope of the following claims.

What is claimed is:

1. A method of dispensing prescription medications to a patient over a select time period comprising the steps of:
receiving a prepared prescription for medication containing prescription data and patient parameters for a select patient;
storing the prescription data and patient parameters;
providing a prescription package having:
a plurality of discrete spatially distinct locations arranged in a two dimensional matrix, the two dimensional matrix including data corresponding to time of day information and a select number of days of a week information, and
a heading region disposed on a portion of the package;
comparing the prescription data to the patient parameters to determine prescription instruction data;
printing prescription instruction data onto the heading region, the prescription instruction data including at least the patient name, medication name, medication dosage and dosage schedule;
packaging the medication in the discrete spatially distinct locations to correspond to the medication dosages and dosage schedule of the prescription instruction data; and
placing a scheduling code on an end of the prescription package, the scheduling code corresponding to the same time of day information as in the matrix.

2. The method of claim 1 comprising the steps of:
providing a plurality of the prescription packages having a two-dimensional matrix and scheduling code for a plurality of medications for the patient;
arranging the prescription packages to form a patient's prescription package set such that the two dimensional matrix and scheduling codes provide a three dimensional matrix in the patient's set for administering the medications to the patient.

3. The method of claim 2 comprising the steps of:
providing a plurality of patient's sets for a plurality of select patients residing at a plurality of patient care facilities, wherein the day of the week information on each prescription package of the patient's sets includes a select start date for administering the packaged medication to each patient; and
distributing the plurality of patient's sets to the plurality of facilities, wherein the start dates are customized to, and uniform for, each facility.

4. The method of claim 2 comprising the step of:
providing the scheduling code as a color code corresponding to time of day information such that a visual indication is given as to the time of day each medication within the patient's set is to be taken by the patient.

5. The method of claim 3 comprising the steps of:
checking the prescription data and patient parameters for each patient on a first time period criteria;
providing the prescription packages having packaged medication based on the checked prescription data and patient parameters;
delivering the packages to the plurality of patients on the first time period criteria; and
billing the patients for the packages on a second time period criteria greater than the first time period criteria.

6. The method of claim 5, wherein the first time period criteria is a weekly criteria and the second time period criteria is a monthly criteria.

7. The method of claim 1 comprising the step of printing the most common side effect of the medication onto the package.

8. The method of claim 1 wherein the package is a blister pack and the discrete spatially distinct locations are blister cavities

9. The method of claim 1 wherein the two-dimensional matrix comprises rows corresponding to the select number of days of the week information and columns corresponding to the time of the day information.

10. The method according to claim 11, further comprising the steps of: contacting the prescriber to verify if more refills should be administered, and reviewing a medication drug profile to determine potential drug interactions and adverse reaction to the medication prescribed.

11. The method according to claim 2, further comprising the steps of: providing education relating to the use of the present method and the administration of the medication prescribed.

12. The method according to claim 2, further comprising the step of storing patient specific health records.

13. The method according to claim 2, further comprising the steps of:
storing names of all medication currently administered to the patient into a computer program; and
comparing medications currently administered and the medication prescribed to determine drug interactions.

14. The method according to claim 2, further comprising the step of comparing medications to a patient health record to determine potential adverse reactions.

15. The method according to claim 13, further comprising the steps of contacting the prescriber when drug interactions are found for clarification before filling out the prescription.

16. The method according to claim 14, further comprising the steps of:
contacting the prescriber when potential adverse reactions are found for clarification before filling out the prescription.

17. The method according to claim 2, further comprising the steps of
monitoring a patient for adverse reactions; and
entering adverse reactions which occur into a database.

18. The method according to claim 2, further comprising the step of entering new patient health data into a computer database.

19. The method according to claim 2, further comprising the step of generating an alarm for incorrect data entered into a computer.

20. The method according to claim 2, further comprising the step of applying a machine-readable code to the package.

21. A system for dispensing prescription medication to a patient over a select time period comprising at least one prescription package, the package having:
a plurality of discrete spatially distinct locations containing the medication arranged in a two dimensional matrix, the matrix including data corresponding to time of day information and select number of days of a week information;
a heading region disposed on a portion of the package, the heading region containing prescription instruction data having the patient's name, medication name, medication dosages and usage schedule; and
a scheduling code disposed on an end of the prescription package, the to scheduling code corresponding to the same time of day information as in the matrix;
wherein the medication is disposed in the discrete spatially distinct locations to correspond to the medication dosages and usage schedule of the prescription instruction data.

22. The system of claim 21 comprising:
a plurality of the packages having a two dimensional matrix and scheduling code for a plurality of medications for the patient;
wherein the packages are arranged to form a patient's prescription package set such that the two dimensional matrix and scheduling codes provide a three dimensional matrix in the patient's set for administering the medications to the patient.

23. The system of claim 22 wherein the scheduling code comprises a color code corresponding to time of day information such that a visual indication is given as to the time of day each medication within the patient's set is to be taken by the patient.

24. The system of claim 21 wherein the package is a blister pack and the discrete spatially distinct locations are blister cavities.

25. The system of claim 21 wherein the two dimensional matrix comprises rows corresponding to the select number of days of the week information and columns corresponding to the time of the day information.

26. A blister pack system for dispensing time sensitive substances to a user over select time periods comprising at least one blister pack, the blister pack having:
a plurality of blister cavities containing the time sensitive substance arranged in columns and rows, the columns and rows including select day information and select time of day information to provide a two dimensional scheduling matrix for dispensation of the time sensitive substance;
a heading region disposed on an upper end portion of the blister pack adjacent to the blister cavities, the heading region containing parameter information identifying a select user and including a substance usage schedule to administer the substance to the user; and
a scheduling code disposed on a top end of the heading region corresponding to one of the select day information and the select time of day information;
wherein the time sensitive substance is disposed in the blister cavities to correspond to the substance usage schedule for the user.

27. The blister pack system of claim 26 wherein the at least one blister pack includes a plurality of blister packs for dispensing a plurality of time sensitive substances for the user, wherein the plurality of blister packs are arranged together such that the rows, columns and scheduling code provide a three dimensional scheduling matrix for administering the time sensitive substances to the user.

28. The blister pack system of claim 26 wherein the time sensitive substances are medications and the user is a patient.

29. The blister pack system of claim 26 wherein the select day information corresponds to a period of less than a month's time.

30. The blister pack system of claim 26 wherein the select day information corresponds to one of a five and a seven day period.

31. The blister pack system of claim 26 wherein:
the rows correspond to the select day information; and
the columns and scheduling code each correspond to the select time of day information.

32. The blister pack system of claim 26 wherein the scheduling code is a color code.
